(19) United States
(12) Patent Application Publication
(10) Pub. No.: US 2015/0302411 A1
(43) Pub. Date: Oct. 22, 2015

(54) PROXIMITY TO A LOCATION AS A FORM OF AUTHENTICATION

(71) Applicant: BANK OF AMERICA CORPORATION, CHARLOTTE, NC (US)

(72) Inventors: Laura Corinne Bondesen, Charlotte, NC (US); Scott Lee Harkey, Concord, NC (US)

(73) Assignee: BANK OF AMERICA CORPORATION, CHARLOTTE, NC (US)

(21) Appl. No.: 14/258,270

(22) Filed: Apr. 22, 2014

(51) Int. Cl. G06Q 20/40; G06Q 20/38

(52) U.S. Cl. CPC G06Q 20/4012; G06Q 20/382

(57) ABSTRACT

Disclosed is a system and associated method of authenticating a transaction based at least partially on the location of a mobile device. The system typically includes a processor, a memory, and a transaction authentication module stored in the memory. The module is typically configured for: receiving a request from a user to complete a transaction; receiving geographic location information for a point-of-transaction associated with the transaction; receiving geographic location information for the mobile device associated with the user; determining whether the geographic location of the point-of-transaction is geographically proximate to the geographic location of the mobile device; and based at least partially on the geographic location of the point-of-transaction being geographically proximate to the geographic location of the mobile device, enabling the user to complete the transaction.

### FIELD OF THE INVENTION

The present invention embraces a system for authenticating a transaction based on the location of a user's mobile device. The system typically includes a processor, a memory, and a transaction authentication module stored in the memory. The transaction authentication module is typically configured for determining whether the geographic location of a transaction involving a user is geographically proximate to the geographic location of a mobile device of the user; and based at least partially on the geographic location of the transaction being geographically proximate to the geographic location of the mobile device, enabling the user to complete the transaction.

### BACKGROUND

In the new technological age, the security of personal information, or the lack thereof, has become an issue that concerns many people. As a result, several business industries, such as financial institutions, have taken precautionary measures to ensure the safety and protection of their customers' information. This is typically accomplished by authenticating a user's identity prior to permitting certain transactions, including transferring any personal information using an electronic means. That said, a need exists for improved ways of verifying a user's identify.

### SUMMARY

In one aspect, the present invention embraces a method of authenticating transactions. The present invention also embraces a system configured for performing one or more of the steps of the method.

The method typically includes: receiving a request from a user to complete a first transaction; determining that the first transaction corresponds to a first level of authentication, the first level of authentication permitting user authentication based at least partially on the geographic location of a transaction being geographically proximate to a mobile device associated with the user; receiving geographic location information for a point-of-transaction associated with the first transaction; receiving geographic location information for the mobile device associated with the user; determining whether the geographic location of the point-of-transaction is geographically proximate to the geographic location of the mobile device; based at least partially on the geographic location of the point-of-transaction being geographically proximate to the geographic location of the mobile device, determining that the user has satisfied the first level of authentication; and based at least partially on the user satisfying the first level of authentication, enabling the user to complete the first transaction.

In an exemplary embodiment, the method further includes: after determining that the user has satisfied the first level of authentication, receiving a request from a user to complete a second transaction; determining that the second transaction corresponds to a second level of authentication, the second level of authentication permitting user authentication based at least partially on receiving authentication credentials from the user; based at least partially on determining that the second transaction corresponds to the second level of authentication, prompting the user to provide the predefined authentication credentials; receiving the predefined authentication credentials from the user; based at least partially on receiving the predefined authentication credentials from the user, determining that the user has satisfied the second level of authentication; and based the user satisfying the second level of authentication, enabling the user to complete the second transaction. In a particular exemplary embodiment, the first transaction comprises initiating an ATM session; the second transaction comprises withdrawing or transferring funds; and the predefined authentication credentials comprises a PIN number associated with the user.

In yet another exemplary embodiment, the method further includes: after determining that the user has satisfied the first level of authentication, receiving a request from a user to complete a third transaction; determining that the third transaction corresponds to the first level of authentication; and based the user satisfying the first level of authentication, enabling the user to complete the third transaction. In a particular exemplary embodiment, the first transaction comprises initiating an ATM session; and the third transaction comprises viewing an account balance.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A depicts a method for authenticating a user in accordance with an aspect of the present invention;

FIG. 1B provides a diagram illustrating an authentication continuum, in accordance with an aspect of the present invention;

FIG. 1C provides a diagram illustrating functions permitted continuum, in accordance with an aspect of the present invention;

FIG. 1D provides a diagram illustrating multiple continuums, in accordance with an aspect of the present invention;

FIG. 2 depicts a banking system and environment in accordance with an aspect of the present invention;

FIG. 3 schematically depicts a transaction machine in accordance with an aspect of the present invention;

FIG. 4 schematically depicts a user's mobile device in accordance with an aspect of the present invention; and

FIG. 5 schematically depicts a banking system in accordance with an aspect of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution.

As used herein, an “online banking account” is an account that is associated with one or more user accounts at a financial institution. For example, the user may have an online banking account that is associated with the user's checking account, savings account, investment account, and/or credit account at a particular financial institution. A username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). In other embodiments, the “customer” may refer to the user.

The embodiments described herein may refer to use of a “transaction.” Unless specifically limited by the context, a transaction refers to any communication between the user and the financial institution or other entity monitoring the user's activities. In some embodiments, for example, a transaction may refer to a purchase of goods or services, a return of goods or services, a payment transaction, a credit transaction, or other interaction involving a user's account. For example, in the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes; and the like); sending remittances; transferring balances from one account to another account; loading money onto stored value cards (SVCs) and/or prepaid cards; donating to charities; and/or the like.

As used herein, a “point-of-transaction” typically refers a location associated with a transaction. A point-of-transaction (e.g., a point of sale (POS)) could refer to any location, virtual location or otherwise proximate occurrence of a transaction. Typically, the point-of-transaction is the location of a point-of-transaction device. A “point-of-transaction device” may refer to any device used to perform a transaction, either from the user's perspective, an entity's perspective or both. In some embodiments, the point-of-transaction device (e.g., transaction device) refers only to a user's device, in other embodiments it refers only to an entity device, and in yet other embodiments, it refers to both a user device and an entity device interacting to perform a transaction. For example, in one embodiment, the point-of-transaction device refers to a merchant's point-of-transaction terminal. In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, and the like), a personal identification number (PIN) payment device, a contactless payment device (e.g., a key fob), a radio frequency identification device (RFID) and the like, a computer, (e.g., a personal computer, tablet computer, desktop computer, server, laptop, and the like), a mobile device (e.g., a smartphone, laptop computer, tablet computer, cellular phone, personal digital assistant (PDA) device, MP3 device, personal GPS device, and the like), a merchant terminal, a self-service machine (e.g., vending machine, self-checkout machine, and the like), a public and/or business kiosk (e.g., an Internet kiosk, ticketing kiosk, bill pay kiosk, and the like), a gaming device, and/or various combinations of the foregoing. In some embodiments, a point-of-transaction device is operated in a public place (e.g., on a street corner, at the doorstep of a private residence, in an open market, at a public rest stop, and the like). In other embodiments, the point-of-transaction device is additionally or alternatively operated in a place of business (e.g., in a retail store, post office, banking center, grocery store, factory floor, and the like). In accordance with some embodiments, the point-of-transaction device may not be owned by the user of the point-of-transaction device. Rather, in some embodiments, the point-of-transaction device is owned by a mobile business operator or a point-of-transaction operator (e.g., merchant, vendor, salesperson, and the like). In yet other embodiments, the point-of-transaction device is owned by the financial institution offering the point-of-transaction device providing functionality in accordance with embodiments of the invention described herein.

In one aspect, the present invention generally relates to a system for authenticating a user based on a mobile device of the user being located proximate to the location of a transaction that the user wishes to complete. In particular, the geographic location of the user's mobile device is typically compared to the geographic location of a point-of-transaction corresponding to the transaction in order to determine if the user's mobile device is located proximate to the transaction. In this regard, if an individual's mobile device is collocated with a point-of-transaction, it is highly likely that the individual making the purchase or otherwise engaging in the transaction is an authorized user of the account that is being used in the transaction. Accordingly, the user may be authenticated and permitted to complete the transaction based on the individual's mobile device being collocated with the point-of-transaction.

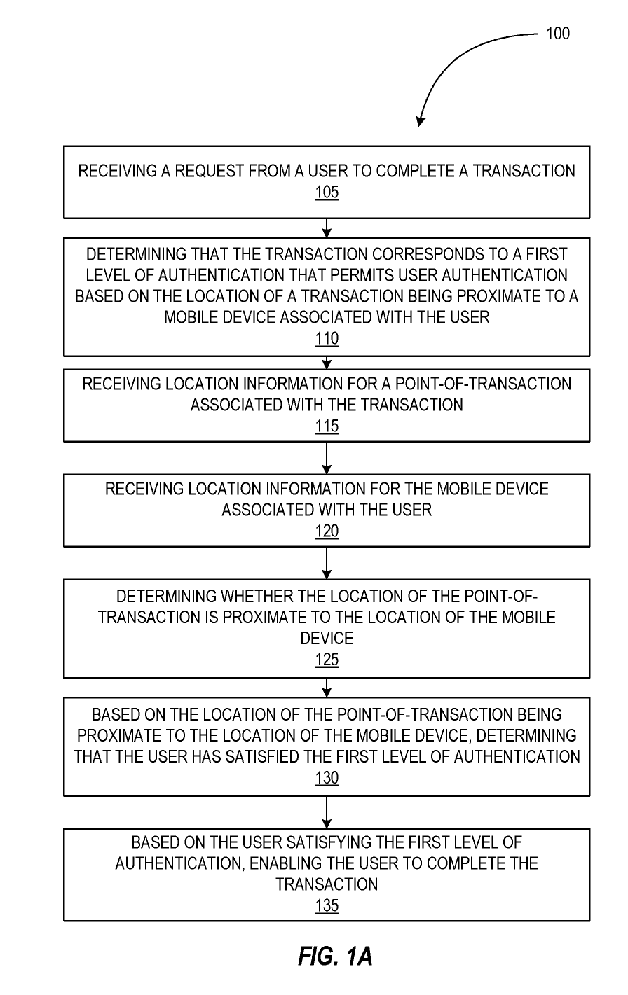

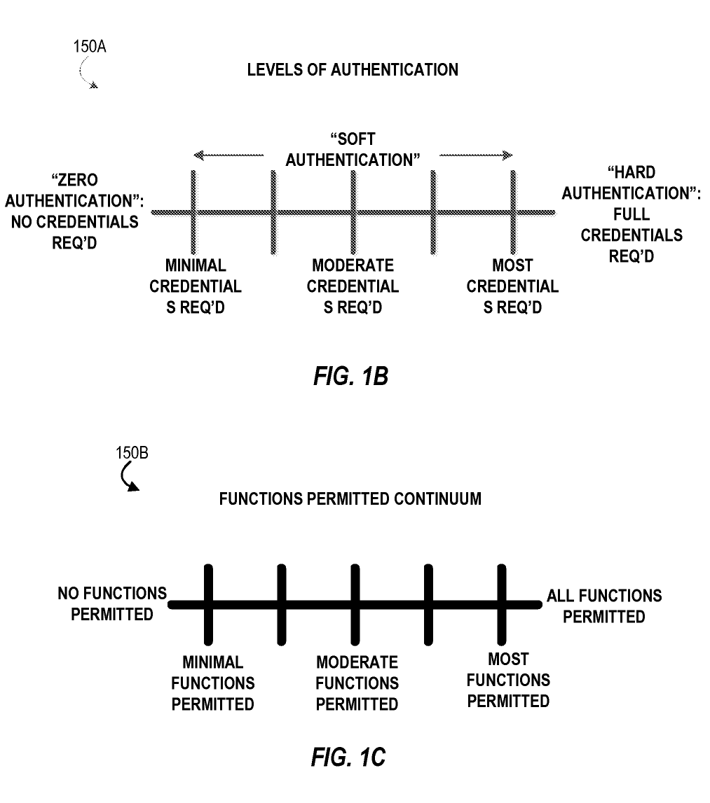

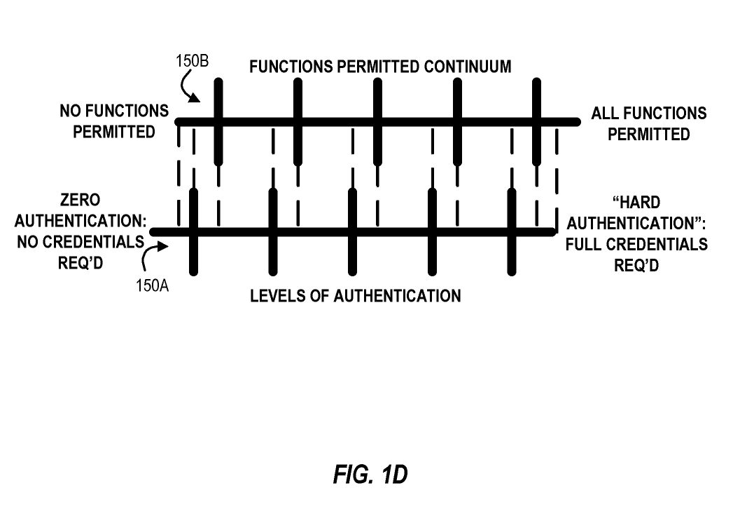

Referring now to FIG. 1A, a general process flow 100 is provided for authenticating a user.

At block 105, the method includes receiving a request from a user to complete a transaction, typically a transaction involving an account that the user has with an entity (e.g., financial institution). This request to complete the transaction is typically received from a transaction device related to the transaction. For example, the user may attempt to initiate an ATM session at an ATM. By way of further example, the user may attempt to initiate an online banking session at a computer. In some embodiments, the user may attempt to make a purchase at a merchant terminal or at a self-service machine.

At block 110, the level of authentication corresponding to the transaction is determined. In particular, it is determined whether the transaction corresponds to a first level of authentication that permits user authentication based on the location (e.g., geographic location) of a transaction being proximate to the location of a mobile device associated with the user. In other words, the first level of authentication may allow user authentication based on mobile device collocation instead of other types of authentication information, such as a password, a personal identification number (PIN), a passcode, biometric information (e.g., voice authentication, a fingerprint, and/or a retina scan), or an answer to a security question.

In this regard, different types of transactions may correspond to different levels of authentication. Different types of authentication may provide differing degrees of confidence regarding the authentication using such types. For example, if a username by itself is used for a first user authentication, and a username along with a password is used for a second authentication, then the second authentication should provide a higher confidence regarding the authentication because of the additional layer of authentication required. Accordingly, a continuum of authentication may be used to quantify (or dictate) levels of authentication. Likewise, a continuum of functions or transactions permitted may be used to quantify (or dictate) the number or context in which functions or transactions are permitted.

Referring to FIG. 1B, a continuum of authentication 150A is illustrated according to embodiments of the invention. On the left-hand side of the continuum, a “zero authentication” requires no authentication credentials. On the right-hand side of the continuum, a “hard authentication” requires full authentication credentials (e.g., authentication information). This means that it requires the strictest combination of credentials. In between the two extremes, “a soft authentication” requires minimal credentials, moderate credentials or most credentials for various points along the continuum. The continuum generally represents the number of credentials required and/or the relative strength of the credentials required for that point on the continuum. As discussed below with reference to FIG. 1D, the continuum of authentication 150A may be coupled with a functions permitted continuum 150B, first illustrated in FIG. 1C.

Referring to FIG. 1C, the functions (e.g., transactions) permitted continuum 150B illustrates various levels of functions permitted. Functions may refer to transactions, such as what a user is permitted to “see” and/or what the user is permitted to “do.” More specifically, this may refer to whether a specific function is permitted at a certain point on the continuum and/or the context in which a certain function is permitted. The left-hand side of the continuum indicates that no functions are permitted, and the right-hand side of the continuum indicates that all functions are permitted. In between the extremes, minimal functions are permitted, moderate functions are permitted and most functions are permitted. Thus, any given point along the continuum 100B corresponds with a certain amount and/or number of functions that are permitted and/or the context in which certain functions are permitted.

Referring now to FIG. 1D, a diagram illustrates a coupling of the functions permitted continuum 150B and the levels of authentication continuum 150A. As shown, the continua 150B and 150A may be coupled with one another such that the various points along the continua intersect at specific points of the coupled continuum. For example, one continuum may be moved left or right with respect to the other continuum in order to achieve a different relationship between the functions permitted and the credentials required. Accordingly, for a given coupling, a specific point on continuum 150B provides that a particular function or functions may be permitted given that a specified level of authentication credentials are supplied, as indicated by the corresponding point on continuum 150A. For example, a financial institution and/or a user may arrange the continua 150B and 150A with respect to one another and may adjust the arrangement based on changing desires or goals.

By way of example, initiating an online banking session, initiating an ATM session, or viewing an account balance may correspond to the first level of authentication, which permits user authentication based on mobile device collocation with the transaction (e.g., in combination with the user providing their online banking username or debit card, as the case may be). In some embodiments, completing a debit card purchase or depositing, withdrawing, or transferring funds (e.g., in an amount less than a predefined threshold) may correspond to the first level of authentication.

Other types of transactions may require alternative or additional (e.g., secondary) authentication information (e.g., a password, passcode, PIN, biometric information, or answer to a security question). Accordingly, in the event that the transaction does not correspond to the first level of authentication, the user is typically prompted to provide authentication information comporting with the determined level of authentication. For example, completing a debit card purchase or depositing, withdrawing, or transferring funds (e.g., in an amount greater than a predefined threshold) may require additional authentication information, such as a password or PIN.

Accordingly, in one embodiment, the user may be able to initiate an ATM session and view an account balance during the ATM session by establishing collocation of the user's mobile device and without the need to provide the user's PIN. That said, the user may be required to provide the PIN if the user wishes to withdrawn funds in excess of a predefined threshold. In another embodiment, the user may be able to initiate an online banking session and view an account balance during the online banking session by establishing collocation of the user's mobile device and without the need to provide the user's online banking password. That said, the user may be required to provide the password if the user wishes to transfer funds in excess of a predefined threshold. In yet another embodiment, the user may be able to complete small purchases with the user's debit card by establishing collocation of the user's mobile device and without the need to provide the user's PIN. That said, the user may be required to provide the PIN if the user wishes to complete large debit card purchases.

The level of authentication that corresponds to each type of transaction may be defined by the user or by the entity. The level of authentication that corresponds to each type of transaction may be stored in a database for subsequent retrieval in order to determine the appropriate level of authentication.

At block 115, geographic location information for a point-of-transaction associated with the transaction is received. This geographic location information may be any information that is suitable for determining the location of the point-of-transaction. Typically, the geographic location information corresponds to the geographic location of the transaction device. For example, this geographic location information may be GPS coordinates or information related to a detected wireless network (e.g., a local area network) that is transmitted by the transaction device. In this regard, the point-of-transaction device may include a GPS receiver/transmitter for transmitting geographic location information indication the location where the transaction is occurring. In other embodiments, the GPS coordinates of the point-of-transaction may be stored in a database. In some embodiments, the location information may include one or more geo-fences that reflect the geographic location of the point-of-transaction. A geo-fence is a virtual perimeter that defines the boundaries of an actual geographic area. In one embodiment, the geographic location information may be information associated with the transaction device being in close proximity with another device (e.g., determined using an NFC interface or other proximity detector). In another embodiment, the geographic location information may include a geographic address associated with the point-of-transaction location. In other embodiments, the geographic location information may include an identifier associated with the point-of-transaction location, which is used as a pointer to a database containing geographic location information associated with the point-of-transaction. For example, a point-of-transaction merchant may be a customer of the entity, in which case the entity maintains address information associated with the point-of-transaction merchant. Accordingly, the point-of-transaction merchant may be identified in order to retrieve address information associated with the point-of-transaction merchant, which can be converted to geographic location data associated with the location of the transaction. In another embodiment, name and other information associated with the point-of-transaction merchant can be used to search public databases and information to determine address and/or geographic location information associated with the point-of-transaction.

At block 120, geographic location information for the user's mobile device is received. In this regard, the user typically has one or more mobile devices associated with their account. Typically, any type of location information may be received. For example, many mobile devices are capable of recognizing and transmitting the GPS coordinates for the position of the mobile device. In some situations, a mobile device may be capable of recognizing a wireless network provided by a store or otherwise associated with a particular location, such as an individual's home wireless network, and use that information to transmit or otherwise make available the location information associated with the mobile device. In one embodiment, the geographic location information may be information associated with the mobile device being in close proximity with the transaction device or another device (e.g., determined using an NFC interface or other proximity detector).

In some exemplary embodiments, the user may provide information about their mobile device to the financial institution or other entity that administers their account. For example, the user may identify a mobile phone, a smartphone, a laptop computer, a tablet computer, and/or any of a number of mobile devices as associated with the user, and allow the financial institution or other entities to receive information about the location of such mobile devices in the context of verifying transactions. Accordingly, the user may provide device identification information associated with the mobile device to the financial institution or other entity, which can subsequently be used to verify the identity of the mobile device. The identification information may be any information sufficient to generate a device “fingerprint,” or unique signature of the device. Device identification information may be collected from a variety of sources. In some embodiments, the device identification information includes an identification code. The identification code may be but is not limited to a serial number or an item number of the device. In some embodiments, the device identification information may be associated with a chip associated with the device. The chip may be but is not limited to a subscriber identification module (SIM) card, removable hard drive, processor, microprocessor, or the like. In other embodiments, the device identification information may be associated with a removable part of the device. Removable parts include but are not limited to detachable keyboards, battery covers, cases, hardware accessories, or the like. Removable parts may contain serial numbers or part numbers. In alternative embodiments, a unique key, code, or piece of software provided by a financial institution may be downloaded onto the device. This unique key, code, or piece of software may then serve as device authentication information. In some embodiments, device identification information may need to be entered manually at the device. For example, the user may be prompted (e.g., via an online banking interface) to manually enter the device identification information (e.g., a serial number, an identification code, an International Mobile Station Equipment Identity (IMEI), a phone number, a chip, a removable part, or similar pieces of device identification information). In other embodiments, device identification information may not be based on user input received at the device. Instead, the device identification information may be automatically provided by the device. In yet another embodiment, the device may provide the information without requiring user input after receiving a request for the identification information.

Next, at block 125, it is determined whether the geographic location of the mobile device is geographically proximate to the geographic location of the point-of-transaction (e.g., by comparing the geographic location information of the mobile device with the geographic location information of the transaction device). In some exemplary embodiments, determining whether the geographic location of the mobile device is geographically proximate to the geographic location of the point-of-transaction includes determining whether the location of the mobile device is located within a predefined distance from the location of the point-of-transaction. It will be appreciated that any approach to determining whether the mobile device is located within a predetermined distance from the point-of-transaction location may be used. For example, a computer processor may compare the GPS coordinates associated with the mobile device with the GPS coordinates associated with the point-of-transaction and calculate a distance. The predefined distance may be a few meters, tens of meters, or an even larger distance. The predetermined distance is somewhat influenced by the margin of error associated with relating the location of the mobile device to the location associated with the point-of-transaction. The more accurate the location information, the tighter the range that can be selected for the predefined distance. In other exemplary embodiments, determining whether the geographic location of the mobile device is geographically proximate to the location of the point-of-transaction includes determining whether the geographic location of the mobile device is within a geo-fence associated with the point-of-transaction. In some exemplary embodiments, determining whether the geographic location of the mobile device is geographically proximate to the point-of-transaction includes determining whether the mobile device is in communication with a predefined wireless network (e.g., a local area network associated with the point-of-transaction) or if the mobile device and the transaction device are in communication with the same wireless network. In further exemplary embodiments, determining whether the geographic location of the mobile device is geographically proximate to the geographic location of the point-of-transaction associated with the mobile device includes determining whether the mobile device and the transaction device are in communication with one another via Near Field Communication (NFC). In this regard an NFC interface on the mobile device and an NFC interface on the transaction device may exchange information. Information regarding this exchange of information via Near Field Communication may then be provided to establish that the mobile device and the transaction device are in close proximity.

If the geographic location of the mobile device is not proximate to point-of-transaction, then, the transaction may be denied or the user may be prompted to provide alternative authentication information.

Based on the geographic location of the point-of-transaction being proximate to the geographic location of the mobile device, at block 130, it is determined that the user has satisfied the first level of authentication, thereby authenticating the identity of the user. In other words, the identity of the first user is authenticated based on the collocation of the mobile device and the transaction and without the need for other authentication information, such as the user's password or PIN.

Based on the user satisfying the first level of authentication, at block 135, the user is enabled (e.g., permitted) to complete the transaction. For example, an online banking session may be initiated between the user and the entity, an ATM session may be initiated between the user and the entity, or a purchase involving the user's account may be completed.

Subsequent transactions may be also be enabled based on the user satisfying the first level authentication. In this regard, if the user requests to complete a subsequent transaction, the level of authentication corresponding to the subsequent transaction is determined. If the subsequent transaction corresponds to the first level of authentication, then the subsequent transaction is enabled. That said, if the subsequent transaction corresponds to a higher level of authentication, then the user is typically prompted to provide the appropriate authentication information before the subsequent transaction is enabled.

By way of example, the user may request to initiate an ATM session at an ATM. The user's identity may be authenticated by determining that the user's mobile device is collocated with the ATM, and the ATM session is thus permitted. Within the ATM session, the user may be permitted to complete other transactions, such as viewing an account balance, based on the initial user authentication by determining that the user's mobile device is collocated with the ATM. That said, other ATM functionality (i.e., transactions) may require additional user authentication. For example, the user may be prompted to enter a PIN before being permitted to withdraw funds in excess of a predefined threshold.

By way of further example, the user may request to initiate an online banking session at a computer. The user's identity may be authenticated by determining that the user's mobile device is collocated with the computer, and the online banking session is thus permitted. Within the online banking session, the user may be permitted to complete other transactions, such as viewing an account balance, based on the initial user authentication by determining that the user's mobile device is collocated with the computer. That said, other online banking functionality (i.e., transactions) may require additional user authentication. For example, the user may be prompted to enter a password before being permitted to transfer funds in excess of a predefined threshold.

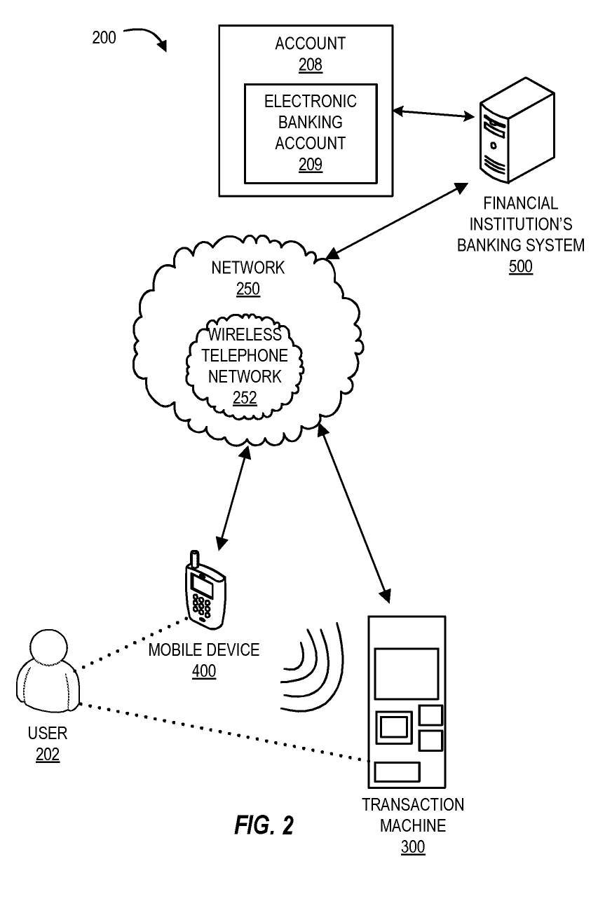

FIG. 2 provides a block diagram illustrating a banking system 500 and environment 200, in accordance with an embodiment of the present invention. As illustrated in FIG. 2, the banking environment 200 typically includes a transaction machine 300 and a mobile device 400. As used herein, a “mobile device” is any mobile communication device, such as a cellular telecommunications device (i.e., a cell phone or mobile phone), personal digital assistant (PDA), a mobile Internet accessing device, a tablet computer, a laptop, or other mobile device. FIG. 2 also depicts a user 202 (e.g., an account holder) and an account 208. The account 208 (e.g., a credit account, a deposit account, and the like) is associated with a banking account 209 (e.g., a credit account, a debit account, an online banking account, a mobile banking account, and the like). As shown, the user 202 is associated with the mobile device 400 and the transaction machine 300. In accordance with some exemplary embodiments, the transaction machine 300 and the banking system 500 are each maintained and/or controlled by the same financial institution. For example, in some embodiments, the user 202 is a customer of the financial institution, the banking system 500 is maintained by the financial institution, and the transaction machine 300 is embodied as an ATM maintained by the financial institution. However, in other embodiments, the transaction machine 300 and the banking system 500 are maintained by separate entities. For example, in some embodiments, the transaction machine 300 is embodied as a POS and/or a point-of-transaction device maintained by a merchant. In accordance with typical embodiments, the mobile device 400 is associated with the user 202 and the user's account 208. The mobile device is typically carried, owned, and/or possessed by the user 202.

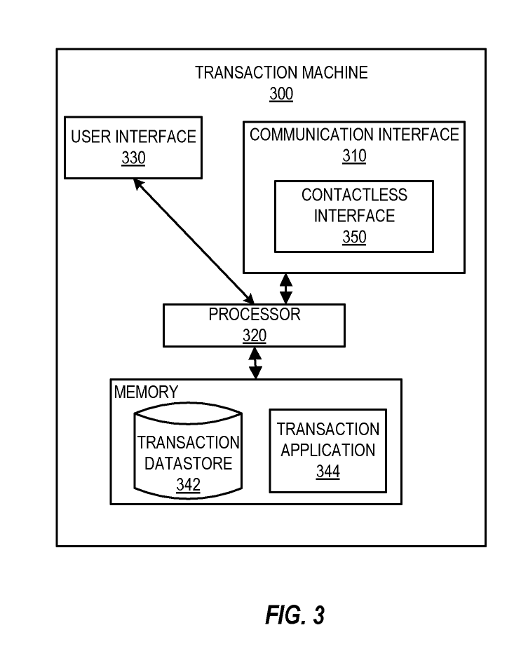

The transaction machine 300 and mobile device 400 are typically configured to communicate over a network 250 with a financial institution's banking system 500. The transaction machine 300, the mobile device 400, and the financial institution's banking system 500 are each described in greater detail below with reference to FIGS. 3-5. The network 250 may include a local area network (LAN), a wide area network (WAN), and/or a global area network (GAN). The network 250 may provide for wireline, wireless, or a combination of wireline and wireless communication between devices in the network. In one embodiment, the network 250 includes the Internet. In one embodiment, the network 250 includes a wireless telephone network 252.

In general, the transaction machine 300, and the mobile device 400 are configured to connect with the network 250 to log the user into or otherwise communicate with the banking system 500. The banking system 500 involves authentication of the user in order to access the user's account on the banking system 500. For example, the banking system 500 may be a system where the user logs into his/her account such that the user can access data that is associated with the user. For example, in one embodiment of the invention, the system 500 may allow the user to use the transaction machine 300 or mobile device 400 to log into the user's online banking account or access the user's account 208. Logging into or accessing the banking system 500 generally requires that the user authenticate his/her identity. As described herein, the user may authenticate his or her identity by establishing the collocation of the transaction machine 300 and the mobile device 400. Authentication may also be established via a user name, a passcode, a cookie, a biometric identifier, a PIN, a private key, a token, and/or another authentication mechanism that is provided by the user to the banking system 500 via the transaction machine 300 and/or the mobile device 400.

The financial institution's banking system 500 is typically in network communication with other devices. In one embodiment, an application download server may be used to download online and/or mobile banking software applications that interacts with the banking system 500 to the mobile device 400 and/or the transaction machine 300. In some embodiments of the invention, the application download server is configured to be controlled and managed by one or more third-party data providers (not shown in FIG. 2) over the network 250. In other embodiments, the application download server is configured to be controlled and managed over the network 250 by the same entity that maintains the banking system 500.

The transaction machine 300 may include any computerized apparatus that can be configured to perform any one or more of the functions of the transaction machine 300 described and/or contemplated herein. It will also be understood that the transaction machine 300 can include and/or be embodied as, any transaction machine described and/or contemplated herein. It will further be understood that the transaction machine 300 can initiate, perform, complete, and/or otherwise facilitate any transaction described and/or contemplated herein as being initiated, performed, and/or otherwise facilitated by a transaction machine. For example, in some embodiments, the transaction machine 300 includes and/or is embodied as an ATM, a POS device, a self-checkout machine, a vending machine, a ticketing kiosk, a personal computer, a gaming device, a mobile phone, and/or the like. As another example, in some embodiments, the transaction machine 300 is configured to initiate, perform, complete, and/or otherwise facilitate one or more financial and/or non-financial transactions, including, for example, purchasing, renting, selling, and/or leasing goods and/or services (e.g., groceries, stamps, tickets, gift certificates, DVDs, and the like), withdrawing cash, making deposits (e.g., cash, checks, and the like), making payments (e.g., paying telephone bills, sending remittances, and the like), accessing the Internet, and/or the like.

As depicted in FIG. 3, the transaction machine 300 typically includes a communication interface 310, a processor 320, a user interface 330, and a memory 340 having a transaction datastore 342 and a transaction application 344 stored therein. As shown, the processor 320 is operatively connected to the communication interface 310, the user interface 330, and the memory 340.

The communication interface 310 of the transaction machine may include a contactless interface 350. In one embodiment, the contactless interface is an NFC interface. The contactless interface 350 is configured to contactlessly and/or wirelessly send and/or receive information over relatively short ranges (e.g., within four inches, within three feet, and the like). The contactless interface 350 may include a transmitter, receiver, smart card, key card, proximity card, Bluetooth® device, radio frequency identification (RFID) tag and/or reader, and/or the like. In some embodiments, the contactless interface 350 communicates information via radio, IR, and/or optical transmissions. Generally, the contactless interface 350 is configured to operate as a contactless transmitter and/or as a contactless receiver. The contactless interface 350 functions to enable transactions with users utilizing an external apparatus capable of contactless communication. Also, it will be understood that the contactless interface 350 may be embedded, built, carried, and/or otherwise supported in and/or on the transaction machine 300. In some embodiments, the contactless interface 350 is not supported in and/or on the transaction machine 300, but the contactless interface 350 is otherwise operatively connected to the transaction machine 300 (e.g., where the contactless interface 350 is a peripheral device plugged into the transaction machine 300). The contactless interface 350 of the transaction machine 300 is configured to contactlessly and/or wirelessly communicate information to and/or from an external device. In some embodiments, the contactless interface 350 may be configured to communicate with the mobile device 400 in order to confirm that the mobile device 400 is collocated with the transaction machine 300.

The communication interface 310 may generally also include a modem, server, transceiver, and/or other device for communicating with other devices and systems (e.g., the system 500) on a network.

The user interface 330 of the transaction machine 300 may include a display (e.g., a liquid crystal display, a touchscreen display, and/or the like) which is operatively coupled to the processor 320. The user interface 330 may include any number of other devices allowing the transaction machine 300 to transmit/receive data to/from a user, such as a keypad, keyboard, touch-screen, touchpad, microphone, mouse, joystick, other pointer device, button, soft key, and/or other input device(s). For example, the user can use the user interface 330 to request and perform transactions (e.g., initiate an ATM session, initiate an online banking session, complete a purchase, transfer funds, withdraw funds, and/or view an account balance).

As further illustrated in FIG. 3, the memory 340 may include one or more transaction applications 344. It will be understood that the transaction application 344 can be executable to initiate, perform, complete, and/or facilitate one or more portions of any embodiment described and/or contemplated herein. Generally, the transaction application 344 is executable to receive transaction instructions from the user and perform typical transaction machine functions, as appreciated by those skilled in the art. For example, in some embodiments, the transaction application 344 is operable to receive transaction information associated with a transaction. As another example, in some embodiments, the transaction application 344 is operable to determine, via the processor 320, that the mobile device 400 associated with the user 202 is collocated (e.g., located within or without a predetermined distance from a location) with the transaction. As still another example, in some embodiments, the transaction application 344 is operable to receive, via the communication interface 310, information indicating that a transaction has been approved or disapproved. As another example, in some embodiments, the transaction application 344 is operable to approve or disapprove a transaction (e.g., based at least partially on a determination that the mobile device 400 associated with the user 202 is geographically proximate to the transaction). In some embodiments, the transaction application 344 is operable to complete one or more transactions at the transaction machine 300 (e.g., complete a purchase transaction, dispense cash, accept a check for deposit, and the like). In some embodiments, where the transaction machine 300 includes and/or is embodied as an ATM, the transaction application 344 is configured to execute on the ATM in order to initiate, perform, complete, and/or facilitate, for example, one or more cash withdrawals, deposits, and/or the like. In other embodiments, where the transaction machine 300 includes and/or is embodied as a point-of-transaction device, the transaction application 344 is configured to execute on the point-of-transaction device in order to initiate, perform, complete, and/or facilitate, for example, one or more debit card and/or credit card transactions. In still other embodiments, where the transaction machine 300 includes and/or is embodied as a personal computer, the transaction application 344 is configured to execute on the personal computer, and, in some embodiments, the transaction application 344 is embodied as a web browser (e.g., for navigating the Internet) that is operable to initiate, perform, complete, and/or otherwise facilitate one or more financial and/or non-financial transactions. In some embodiments, the transaction application 344 is operable to enable the user 202 and/or transaction machine 300 to communicate with one or more other portions of the system 200, and/or vice versa. In some embodiments, the transaction application 344 is additionally or alternatively operable to initiate, perform, complete, and/or otherwise facilitate one or more financial and/or non-financial transactions. In some embodiments, the transaction application 344 includes one or more computer-executable program code portions for causing and/or instructing the processor 320 to perform one or more of the functions of the transaction application 344 and/or transaction machine 300 described and/or contemplated herein. In some embodiments, the transaction application 344 includes and/or uses one or more network and/or system communication protocols.

The transaction machine 300 typically requires users to identify and/or authenticate themselves to the transaction machine 300 and/or banking system 500 before the transaction machine 300 will initiate, perform, complete, and/or facilitate a transaction. For example, in some embodiments, the transaction machine 300 is configured (and/or the transaction application 344 is executable) to authenticate the user based at least partially on the mobile device 400 being collocated with the transaction machine 300. User authentication may also or alternatively be based at least partially on an ATM debit card, smart card, token (e.g., USB token, etc.), username, password, PIN, biometric information, and/or one or more other credentials that the user presents to the transaction machine 300. Additionally or alternatively, in some embodiments, the transaction machine 300 is configured to authenticate a user by using one-, two-, or multi-factor authentication. For example, in some embodiments, the transaction machine 300 requires two-factor authentication, such that the user must provide a valid debit card and establish mobile device collocation or enter the correct PIN associated with the debit card in order to authenticate the user to the transaction machine 300. Alternatively, the user may be able to provide their online banking username and establish mobile device collocation or provide their password for authentication. In some embodiments, authenticating the user by establishing that the mobile device 400 is collocated with the transaction machine 300 may enable the user to access certain transaction machine functionality (e.g., view an account balance), but other transaction machine functionality (e.g., transfer funds) may require additional authentication, such as the user's PIN or password.

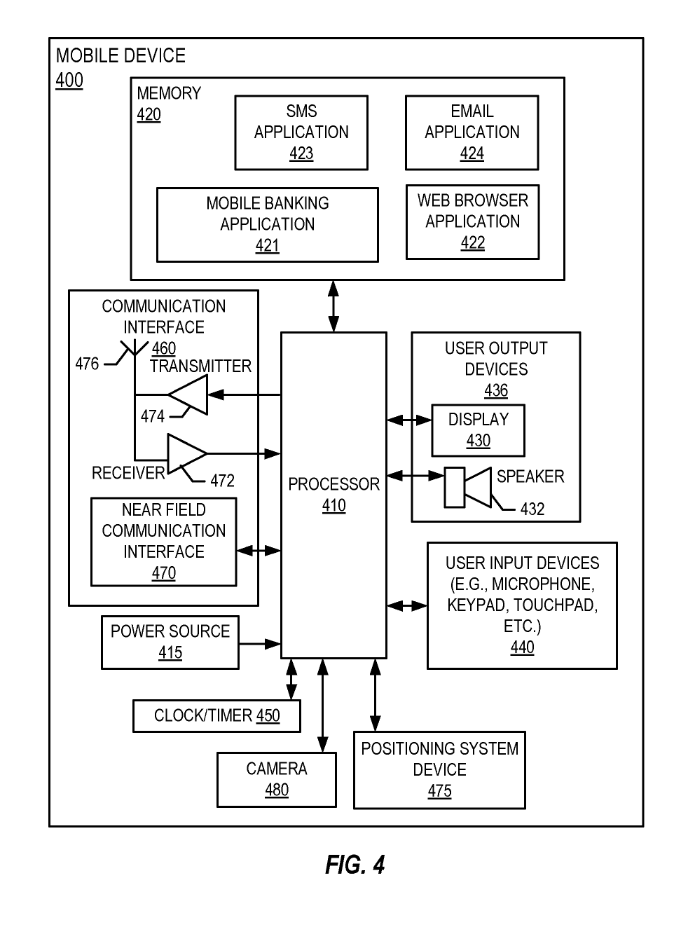

FIG. 4 provides a block diagram illustrating the mobile device 400 in more detail, in accordance with embodiments of the invention. In one embodiment of the invention, the mobile device 400 is a mobile telephone. However, it should be understood, however, that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, cameras, video recorders, audio/video player, radio, GPS devices, or any combination of the aforementioned.

The mobile device 400 typically includes a processor 410 communicably coupled to such devices as a memory 420, user output devices 436, user input devices 440, a communication interface 460, a power source 415, a clock or other timer 450, a camera 480, and a positioning system device 475. The processor 410, and other processors described herein, typically includes circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like.

The processor 410 is typically configured to use the communication interface 460 to communicate with one or more other devices on the network 250. In this regard, the communication interface 460 typically includes an antenna 476 operatively coupled to a transmitter 474 and a receiver 472 (together a “transceiver”). The processor 410 is typically configured to provide signals to and receive signals from the transmitter 474 and receiver 472, respectively. The signals may include signaling information in accordance with the air interface standard of the applicable cellular system of the wireless telephone network 252. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The communication interface 460 may also include a near field communication (NFC) interface 470. As used herein, the phrase “NFC interface” generally refers to hardware and/or software that is configured to contactlessly and/or wirelessly send and/or receive information over relatively short ranges (e.g., within four inches, within three feet, within fifteen feet, and the like). The NFC interface 470 may include a smart card, key card, proximity card, Bluetooth® device, radio frequency identification (RFID) tag and/or reader, transmitter, receiver, and/or the like. In some embodiments, the NFC interface 470 communicates information via radio, infrared (IR), and/or optical transmissions. In some embodiments, the NFC interface 470 is configured to operate as an NFC transmitter and/or as an NFC receiver (e.g., an NFC reader). Also, it will be understood that the NFC interface 470 may be embedded, built, carried, and/or otherwise supported in and/or on the mobile device 400. In some embodiments, the NFC interface 470 is not supported in and/or on the mobile device 400, but the NFC interface 470 is otherwise operatively connected to the mobile device 400 (e.g., where the NFC interface 470 is a peripheral device plugged into the mobile device 400). Other apparatuses having NFC interfaces mentioned herein may be configured similarly. In some embodiments, the NFC interface 470 of the mobile device 400 is configured to contactlessly and/or wirelessly communicate information to and/or from a corresponding NFC interface of another apparatus (e.g., the transaction machine 300).

The mobile device 400 typically has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device 400 to receive data from a user such as the user, may include any of a number of devices allowing the mobile device 400 to receive data from a user, such as a keypad, keyboard, touch-screen, touchpad, microphone, mouse, joystick, other pointer device, button, soft key, and/or other input device(s). The user interface may also include a camera 480, such as a digital camera.

The mobile device 400 may also include a positioning system device 475 that is configured to be used by a positioning system to determine a location of the mobile device 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device 400. In other embodiments, the positioning system device 475 includes a proximity sensor or transmitter, such as an RFID tag, that can sense or be sensed by devices known to be located proximate a location to determine that the mobile device 400 is located proximate these known devices.

The mobile device 400 further includes a power source 415, such as a battery, for powering various circuits and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which include computer-executable instructions/code executed by the processor 410 to implement the functions of the mobile device 400 described herein. For example, the memory 420 may include such applications as a conventional web browser application 422 and/or a mobile banking application 421. These applications also typically provide a graphical user interface (GUI) on the display 430 that allows the user to communicate with the banking system 500 and/or other devices or systems. In one embodiment of the invention, the user may download or otherwise obtains a mobile banking system client application from the banking system 500 or from a distinct application server. In other embodiments of the invention, the user may interact with the banking system 500 via the web browser application 422 or other application in addition to, or instead of, the mobile banking application 421. The banking system 500 is typically configured to present a graphical user interface (e.g., through a mobile banking application or mobile banking website) that allows the user to use the mobile device 400 to control access to the user's online banking account.

The memory 420 can also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information.

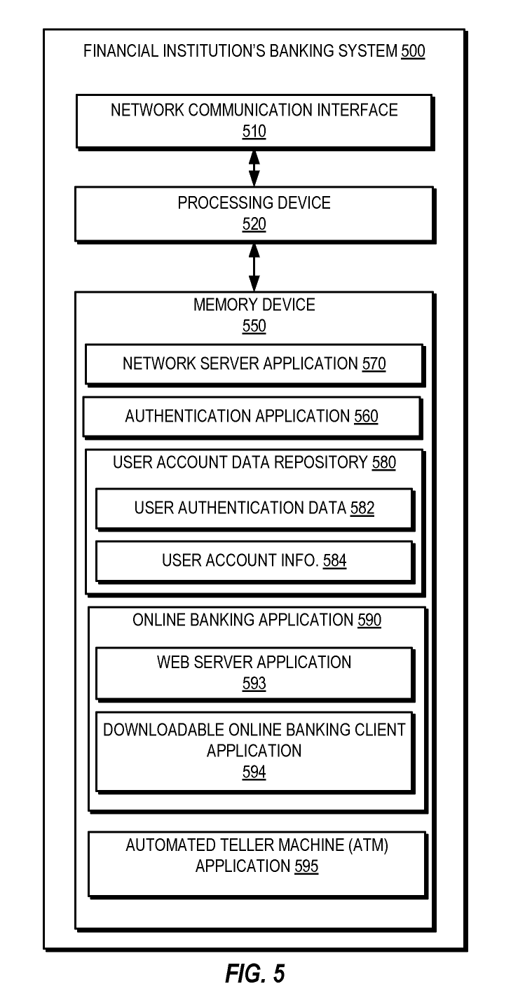

FIG. 5 provides a block diagram illustrating the banking system 500 in greater detail, in accordance with an embodiment of the invention. As illustrated in FIG. 5, in one embodiment of the invention, the banking system 500 includes a processing device 520 operatively coupled to a network communication interface 510 and a memory device 550. In certain embodiments, the banking system 500 is operated by a financial institution, while in other embodiments, the banking system 500 is operated by an entity other than a financial institution.

It should be understood that the memory device 550 may include one or more databases or other data structures/repositories. The memory device 550 also includes computer-executable program code that instructs the processing device 520 to operate the network communication interface 510 to perform certain communication functions of the banking system 500 described herein. For example, in one embodiment of the banking system 500, the memory device 550 includes, but is not limited to, a network server application 570, an authentication application 560 (e.g., an authentication module), a user account data repository 580 which includes user authentication data 580 and user account information 584, an online banking application 590 which includes a web server application 593, a downloadable online banking client application 594, an automated teller machine (ATM) application 595, and other computer-executable instructions or other data. The computer-executable program code of the network server application 570, the authentication application 560, the online banking application 590, or the automated teller machine (ATM) application 595 may instruct the processing device 520 to perform certain logic, data-processing, and data-storing functions of the banking system 500 described herein, as well as communication functions of the banking system 500. In this regard, the processing device 520 is typically configured to authenticate the identity of the user and, thereafter, to enable the user to perform one or more transaction as described herein. To accomplish this, the processing device 520 may communicate with the mobile device 400 and/or transaction machine 300 to facilitate user authentication and enable users to perform transaction. The processing device 520 may also be configured to determine the level of authentication corresponding to transactions that the user wishes to complete.

In one embodiment, the user account data repository 580 includes user authentication data 582 and user account information 584. The network server application 570, the authentication application 560, and the online banking application 590 are configured to employ user account information 584 and the user authentication data 582 when authenticating a user to the banking system 500. In this regard, the user authentication data 582 may include a user's username, password, PIN number, and device identification information associated with a mobile device. The user account information 584 may include account identification information.

As used herein, a “communication interface” typically includes a modem, server, transceiver, and/or other device for communicating with other devices on a network, and/or a user interface for communicating with one or more users. Referring again to FIG. 5, the network communication interface 510 is a communication interface having one or more communication devices configured to communicate with one or more other devices on the network 250, such as the transaction machine 300 and the mobile device 400. The processing device 520 is typically configured to use the network communication interface 510 to transmit and/or receive data and/or commands to and/or from the other devices connected to the network 250.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for authenticating transactions, comprising:
a computer apparatus including a processor and a memory; and
a transaction authentication module stored in the memory, executable by the processor and configured for:
receiving a request from a user to complete a first transaction;
determining that the first transaction corresponds to a first level of authentication, the first level of authentication permitting user authentication based at least partially on the geographic location of a transaction being geographically proximate to a mobile device associated with the user;
receiving geographic location information for a point-of-transaction associated with the first transaction;
receiving geographic location information for the mobile device associated with the user;
determining whether the geographic location of the point-of-transaction is geographically proximate to the geographic location of the mobile device;
based at least partially on the geographic location of the point-of-transaction being geographically proximate to the geographic location of the mobile device, determining that the user has satisfied the first level of authentication; and
based at least partially on the user satisfying the first level of authentication, enabling the user to complete the first transaction.

2. The system according to claim 1, wherein the transaction authentication module is configured for:
after determining that the user has satisfied the first level of authentication, receiving a request from a user to complete a second transaction;
determining that the second transaction corresponds to a second level of authentication, the second level of authentication permitting user authentication based at least partially on receiving authentication credentials from the user;
based at least partially on determining that the second transaction corresponds to the second level of authentication, prompting the user to provide the predefined authentication credentials;
receiving the predefined authentication credentials from the user;
based at least partially on receiving the predefined authentication credentials from the user, determining that the user has satisfied the second level of authentication; and
based the user satisfying the second level of authentication, enabling the user to complete the second transaction.

3. The system according to claim 2, wherein:
the first transaction comprises initiating an ATM session;
the second transaction comprises withdrawing or transferring funds; and
the predefined authentication credentials comprises a PIN number associated with the user.

4. The system according to claim 1, wherein the transaction authentication module is configured for:
after determining that the user has satisfied the first level of authentication, receiving a request from a user to complete a third transaction;
determining that the third transaction corresponds to the first level of authentication; and
based the user satisfying the first level of authentication, enabling the user to complete the third transaction.

5. The system according to claim 4, wherein:
the first transaction comprises initiating an ATM session; and
the third transaction comprises viewing an account balance.

6. The system according to claim 1, wherein determining whether the geographic location of the point-of-transaction is geographically proximate to the geographic location of the mobile device comprises determining whether the geographic location of the mobile device is geographically located within a predetermined distance from the geographic location associated with the mobile device.

7. A computer program product for authenticating transactions, comprising a non-transitory computer-readable storage medium having computer-executable instructions for:
receiving a request from a user to complete a first transaction;
determining that the first transaction corresponds to a first level of authentication, the first level of authentication permitting user authentication based at least partially on the geographic location of a transaction being geographically proximate to a mobile device associated with the user;
receiving geographic location information for a point-of-transaction associated with the first transaction;
receiving geographic location information for the mobile device associated with the user;
determining whether the geographic location of the point-of-transaction is geographically proximate to the geographic location of the mobile device;
based at least partially on the geographic location of the point-of-transaction being geographically proximate to the geographic location of the mobile device, determining that the user has satisfied the first level of authentication; and
based the user satisfying the first level of authentication, enabling the user to complete the first transaction.

8. The computer program product according to claim 7, wherein the non-transitory computer-readable storage medium has computer-executable instructions for:
after determining that the user has satisfied the first level of authentication, receiving a request from a user to complete a second transaction;
determining that the second transaction corresponds to a second level of authentication, the second level of authentication permitting user authentication based at least partially on receiving authentication credentials from the user;
based at least partially on determining that the second transaction corresponds to the second level of authentication, prompting the user to provide the predefined authentication credentials;
receiving the predefined authentication credentials from the user;
based at least partially on receiving the predefined authentication credentials from the user, determining that the user has satisfied the second level of authentication; and
based the user satisfying the second level of authentication, enabling the user to complete the second transaction.

9. The computer program product according to claim 8, wherein:
the first transaction comprises initiating an ATM session;
the second transaction comprises withdrawing or transferring funds; and
the predefined authentication credentials comprises a PIN number associated with the user.

10. The computer program product according to claim 7, wherein the non-transitory computer-readable storage medium has computer-executable instructions for:
after determining that the user has satisfied the first level of authentication, receiving a request from a user to complete a third transaction;
determining that the third transaction corresponds to the first level of authentication; and
based the user satisfying the first level of authentication, enabling the user to complete the third transaction.

11. The computer program product according to claim 10, wherein:
the first transaction comprises initiating an ATM session; and
the third transaction comprises viewing an account balance.

12. The computer program product according to claim 7, wherein determining whether the geographic location of the point-of-transaction is geographically proximate to the geographic location of the mobile device comprises determining whether the geographic location of the mobile device is geographically located within a predetermined distance from the geographic location associated with the mobile device.

13. A method for authenticating transactions, comprising:
receiving, via a computer processor, a request from a user to complete a first transaction;
determining, via a computer processor, that the first transaction corresponds to a first level of authentication, the first level of authentication permitting user authentication based at least partially on the geographic location of a transaction being geographically proximate to a mobile device associated with the user;
receiving, via a computer processor, geographic location information for a point-of-transaction associated with the first transaction;
receiving, via a computer processor, geographic location information for the mobile device associated with the user;
determining, via a computer processor, whether the geographic location of the point-of-transaction is geographically proximate to the geographic location of the mobile device;
based at least partially on the geographic location of the point-of-transaction being geographically proximate to the geographic location of the mobile device, determining, via a computer processor, that the user has satisfied the first level of authentication; and
based the user satisfying the first level of authentication, enabling, via a computer processor, the user to complete the first transaction.

14. The method according to claim 13, comprising:
after determining that the user has satisfied the first level of authentication, receiving a request from a user to complete a second transaction;
determining that the second transaction corresponds to a second level of authentication, the second level of authentication permitting user authentication based at least partially on receiving authentication credentials from the user;
based at least partially on determining that the second transaction corresponds to the second level of authentication, prompting the user to provide the predefined authentication credentials;
receiving the predefined authentication credentials from the user;
based at least partially on receiving the predefined authentication credentials from the user, determining that the user has satisfied the second level of authentication; and
based the user satisfying the second level of authentication, enabling the user to complete the second transaction.

15. The method according to claim 14, wherein:
the first transaction comprises initiating an ATM session;
the second transaction comprises withdrawing or transferring funds; and
the predefined authentication credentials comprises a PIN number associated with the user.

16. The method according to claim 13, comprising:
after determining that the user has satisfied the first level of authentication, receiving a request from a user to complete a third transaction;
determining that the third transaction corresponds to the first level of authentication; and
based the user satisfying the first level of authentication, enabling the user to complete the third transaction.

17. The method according to claim 16, wherein:
the first transaction comprises initiating an ATM session; and
the third transaction comprises viewing an account balance.

18. The method according to claim 13, wherein determining whether the geographic location of the point-of-transaction is geographically proximate to the geographic location of the mobile device comprises determining whether the geographic location of the mobile device is geographically located within a predetermined distance from the geographic location associated with the mobile device.
